(19) United States
(12) Patent Application Publication
(10) Pub. No.: US 2014/0118145 A1
(43) Pub. Date: May 1, 2014

(54) WIRELESS THEFT DETECTION SYSTEM, METHOD AND COMPUTER PROGRAM

(71) Applicant: Sony Corporation, Minato-ku (JP)

(72) Inventors: Laurent WAWRZYNIAK, Ribeauville Cedex (FR); Jerome Vernet, Ribeauville Cedex (FR); Philippe Heinrich, Ribeauville Cedex (FR); Celine Baffrey, Ribeauville Cedex (FR)

(73) Assignee: Sony Corporation, Minato-ku (JP)

(21) Appl. No.: 14/056,027

(22) Filed: Oct. 17, 2013

(30) Foreign Application Priority Data
Oct. 26, 2012 (EP) 12007383.8

(51) Int. Cl. G08B 13/22

(52) U.S. Cl. CPC G08B 13/22
USPC 340/568.8

(57) ABSTRACT

A wireless theft detection system comprises a device holder and a docking station. The device holder includes a first wireless communication module adapted to establish a wireless link with an external second wireless communication module, a first alarm module, and a first processing module. The docking station includes the second wireless communication module, a second alarm module, and a second processing module. The first wireless communication module is adapted to generate first link quality information or the second wireless communication module is adapted to generate second link quality information, and both the first processing module and the second processing module are adapted to control the first and the second alarm module to generate a first and a second alarm signal, respectively, when a quality of the wireless link is below a predetermined threshold value.

### BACKGROUND

1. Field of the Disclosure

The present disclosure relates to a theft detection system and a corresponding method for preventing theft of merchandise items in a retail store.

2. Description of Related Art

Numerous anti-shoplifting systems have been developed and deployed to prevent shoplifting in retail stores. Such systems include simple mechanical protection such as e.g. showcases made of glass in which merchandise items are placed. Items placed in such showcases can be viewed by the customer and may only be touched and tested under the supervision of a clerk.

Moreover, high-end consumer electronics such as e.g. digital cameras, video cameras and smart phones are often secured mechanically with relatively short wires and cables. This kind of anti-shoplifting protection allows a customer to inspect and test an electronic device. However, the test experience is still limited due to the attached wires and cables.

Finally, there exist various electronic surveillance systems which trigger an alarm when a thief attempts to exit a store with an unpaid merchandise item.

Electronic Article Surveillance (EAS) systems are a well-known for preventing shoplifting in retail stores. There are several types of EAS systems including e.g. magnetic systems, acousto-magnetic systems and radio frequency systems. Special transponders are affixed to merchandise items and can only be removed or deactivated by the clerks. For instance, detectors positioned in the exit area of a retail shop are configured to emit an electromagnetic field which is altered in a characteristic way by the transponder. Upon the detection of a transponder in the exit area, an alarm is triggered. Hence, an attempt to remove an unpaid merchandise item from the retail store will result in an alarm.

However, EAS systems provide the disadvantage that most systems can be circumvented by placing the merchandise item together with the transponder in a bag lined with aluminum foil. The latter bag acts as a Faraday cage shielding the transponder from the electro-magnetic field emitted from the detector.

It is therefore an object of the invention to provide a theft detection system which provides an enhanced test experience for the customer, in particular for testing portable electronic devices. Moreover, it is an object of the invention to provide a theft detection system which cannot be easily circumvented.

### SUMMARY

These objects are solved by a system, a method and a computer program according to the independent claims.

Further details of the invention will become apparent from the consideration of the drawings and the ensuing description.

A wireless theft detection system comprises a device holder and a docking station. On the one hand, the device holder includes a first wireless communication module adapted to establish a wireless link with an external second wireless communication module, a first alarm module adapted to generate a first alarm signal, and a first processing module adapted to communicate with the first wireless communication module and to control the first alarm module. On the other hand, the docking station includes the second wireless communication module adapted to establish the wireless link with the first wireless communication module of the device holder, a second alarm module adapted to generate a second alarm signal, and a second processing module adapted to communicate with the second wireless communication module and to control the second alarm module. The first wireless communication module is adapted to generate first link quality information or the second wireless communication module is adapted to generate second link quality information. Both the first processing module and the second processing module are adapted to control the first and the second alarm module to generate the first and the second alarm signal, respectively, when a quality of the wireless link is below a predetermined threshold value.

Furthermore, a method for a wireless theft detection system comprising a device holder and a docking station comprises the steps of establishing a wireless link between the device holder and the docking station, determining a quality of the wireless link in at least one of the device holder and the docking station, generating a first alarm signal in the device holder when the determined quality of the wireless link is below a predetermined threshold value, and generating a second alarm signal in the docking station when the determined quality of the wireless link is below the predetermined threshold value. Moreover, a computer program for a wireless theft detection system is claimed which instructs microprocessors of the device holder and the docking station such that the device holder and the docking station perform the above-mentioned steps.

The foregoing paragraphs have been provided by way of general introduction, and are not intended to limit the scope of the following claims. The described embodiments, together with further advantages, will be best understood by reference to the following detailed description taken in conjunction with the accompanying drawings. The elements of the drawings are not necessarily to scale relative to each other.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an embodiment of a wireless theft detection system.

FIG. 2 illustrates a conceptional view of an embodiment of a device holder.

FIG. 3 illustrates a conceptional view of an embodiment of a docking station.

### DESCRIPTION OF THE EMBODIMENTS

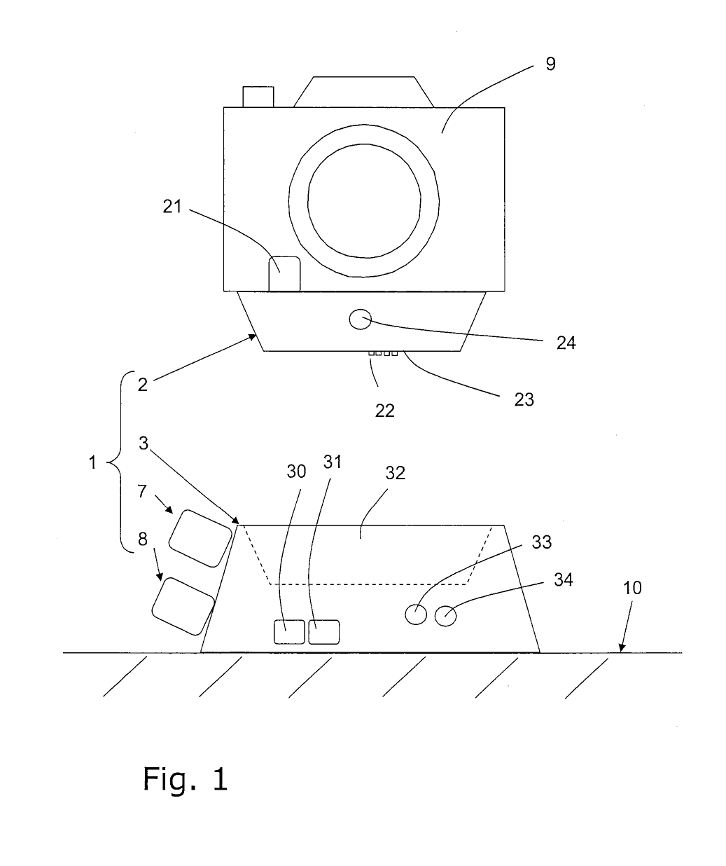

Referring now to the drawings, wherein like reference numerals designate identical or corresponding parts throughout the several views, FIG. 1 illustrates an embodiment of a wireless theft detection system 1 comprising a device holder 2 and a docking station 3. In FIG. 1, an exemplary application scenario of the wireless theft detection system 1 is depicted in which the wireless theft detection system 1 is used to secure a digital camera 9. In general, the wireless theft detection system 1 is not limited to secure digital cameras 9, but can be used to secure all kinds of electronic devices which are exhibited in an exhibition booth in a retail store such as e.g. video cameras, smart phones, or tablet PCs. Another electronic device which may be secured using the wireless theft detection system 1 is a motion-sensing, wireless game controller for a game console. Moreover, application scenarios are not even limited to electronic devices. In principle, any item may be secured using the wireless theft detection system 1 of the present invention. In the following, to simplify the description, the item to which the device holder 2 is attached to will be denoted as “the device” 9.

The device holder 2 is attachable to the device 9, e.g. the digital camera 9, such that a customer cannot easily separate the device 9 from the device holder 2 without using a particular tool or brute force. To this end, techniques well-known in the art may be used. For example, the housing of the device holder 2 may comprise holes for fastening the device holder 2 on device 9 using screws.

Moreover, the device holder 2 may comprise protecting means 21 for securing accessories installed on the device 9. The accessories installed on the device 9 include e.g. memory cards, batteries, Subscriber Identity Module (SIM) cards for mobile phones, or lenses of photo cameras. For example, the embodiment displayed in FIG. 1 provides a lens locking mechanism 21 for mechanically securing a changeable lens of the digital camera 9. The lens locking mechanism 21 is adapted to prevent a customer from removing the lens of the digital camera 9. To be more specific, the lens locking mechanism 21 is adapted to prevent the customer from pressing an unlock button which is used to release the lens.

The device holder 2 further comprises a first alarm module 24 which is adapted to generate optical and/or acoustical alarm signals. For this purpose, the first alarm module 24 may comprise e.g. display devices such as one or more light-emitting diodes (LED) and a loudspeaker. The embodiment of the device holder 2 depicted in FIG. 1 comprises a single LED and a loudspeaker (not shown). The LED 24 might be adapted to blink with different colors and with different modes (e.g. permanent ON, permanent OFF, fast blinking, slow blinking, etc.).

The docking station 3 comprises a second alarm module 34 which is similar but not necessarily identical to the first alarm module 24 of the device holder 2. Also the second alarm module 34 is adapted to generate optical and/or acoustical alarm signals. In the embodiment displayed in FIG. 1, the second alarm module 34 is identical to the first alarm module 24 of the device holder 2, i.e. it comprises a single LED and a loudspeaker.

As illustrated in FIG. 1, the device holder 2 is mechanically and electrically connectable to the docking station 3. The connection is established by forming corresponding counterpart-structures at the device holder 2 and the docking station 3. For instance, the counterpart-structures might be realized as a convexity 23, which fits into a concavity 32 of the docking station 3. The counterpart-structures include metallic pins 22 to establish an electrical connection between the device holder 2 and the docking station 3, the electrical connection being suitable for exchanging both electrical energy and one or more data signals between the device holder 2 and the docking station 3. In principle, the connection between the device holder 2 and the docking station 3 may be established in a different way by some extra features, for example by adding a further convexity which fits into an additional concavity. Alternatively, the device holder 2 and the docking station 3 may be connectable using simple wires.

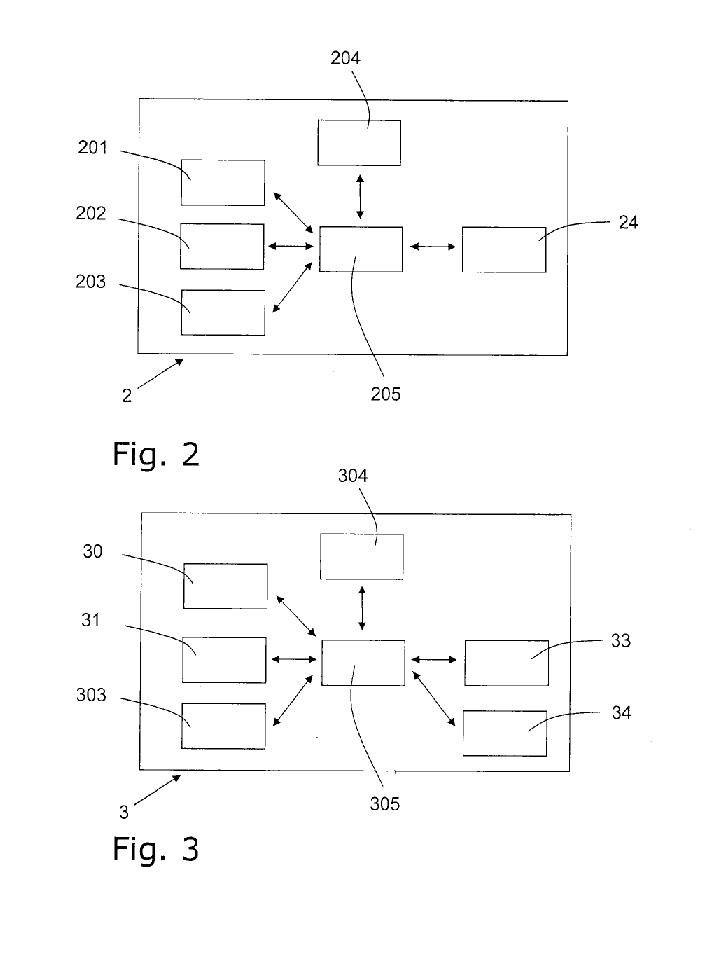

FIG. 2 and FIG. 3 illustrate conceptional views of the device holder 2 and the docking station 3, respectively, which correspond to the embodiment depicted in FIG. 1.

As depicted in FIG. 2 and FIG. 3, both the device holder 2 and the docking station 3 include processing modules. For the sake of clarity, the processing module of the device holder 2 is denoted as first processing module 205 and the processing module of the docking station 3 is denoted as second processing module 305. The first processing module 205 and the second processing module 305 are not necessarily identical.

A processing module in accordance with this disclosure can be implemented using a microprocessor or its equivalent, such as a central processing unit (CPU) or at least one application specific processor ASP. The microprocessor utilizes a computer readable storage medium, such as a memory (e.g., ROM, EPROM, EEPROM, flash memory, static memory, DRAM, SDRAM, and their equivalents), configured to control the microprocessor to perform and/or control the processes and devices of this disclosure.

The microprocessor or aspects thereof, in an alternate embodiment, can include or exclusively include a logic device for augmenting or fully implementing this disclosure. Such a logic device includes, but is not limited to, an application-specific integrated circuit (ASIC), a field programmable gate array (FPGA), a generic-array of logic (GAL), and their equivalents. The microprocessor can be a separate device or a single processing mechanism. Further, this disclosure can benefit from parallel processing capabilities of a multi-cored CPU.

As depicted in FIG. 2 and FIG. 3, the device holder 2 comprises a first wireless communication module 204 and the docking station 3 comprises a second wireless communication module 304. The first wireless communication module 204 and the second wireless communication module 304 are not necessarily identical with respect to their software and hardware configuration. However, the first wireless communication module 204 and the second wireless communication module 304 are adapted to establish a wireless link using the same communication protocol, e.g. a communication protocol based on an IEEE 802 standard such as ZigBee or Bluetooth. For example, the first wireless communication module 204 and second wireless communication module 304 may establish a ZigBee network wherein the second wireless communication module 304 is adapted to act as a ZigBee Coordinator and the first wireless communication module 204 is adapted to act as a ZigBee Endpoint.

Moreover, the first wireless communication module 204 and the second wireless communication module 304 are adapted to establish a bidirectional wireless link which enables exchange of data and/or control signals in both directions, i.e. from the first wireless communication module 204 to the second wireless communication module 304 and from the second wireless communication module 304 to the first wireless communication module 204. For this purpose, both communication modules comprise corresponding radios with one or more antennas. Preferably, the wireless communication modules further comprise processing modules similar to the processing modules 205 and 305 for partly or completely implementing the protocol stack of the chosen communication protocol.

The first wireless communication module 204 is adapted to generate first link quality information or the second wireless communication module 304 is adapted to generate second link quality information. In other words, it is sufficient that either the first or the second wireless communication module is adapted to generate respective link quality information. In addition, it is also possible that both wireless communication modules are adapted to generate respective link quality information. The link quality information characterizes the quality of the wireless channel between the docking station 3 and the device holder 2. In case the first wireless communication module 204 and the second wireless communication module 304 are adapted to establish a ZigBee network, at least one of the wireless communication modules is adapted to generate a Link Quality Indicator (LQI) as link quality information. In general, the link quality information may comprise one or more of the following: a Link Quality Indicator (LQI), a Received Signal Strength Indicator (RSSI), a Signal to Noise Ratio (SNR), and a Signal to Interference plus Noise Ratio (SINR).

In the device holder 2, the first processing module 205 is adapted to communicate with the first wireless communication module 204 and to control the first alarm module 24 and in the docking station 3, the second processing module 305 adapted to communicate with the second wireless communication 304 module and to control the second alarm module 34. Both the first processing module 205 and the second processing module 305 are adapted to control the first alarm module 24 and the second alarm module 34 to generate the first and the second alarm signal, respectively, when a quality of the wireless link is below a predetermined threshold value. The quality of the wireless link is determined by the first and/or second processing module as a combination of one or more information elements of the first and/or second link quality information.

At this, the quality of the wireless link serves as a measure to estimate the physical distance between the device holder 2 and the docking station 3. The predetermined threshold value is e.g. determined in a pre-operational phase in experimental studies such that the predetermined threshold value corresponds to a physical distance of a few meters. By adjusting the predetermined threshold value, it becomes possible to adjust a detection range of the wireless theft detection system 1, i.e. the distance between the device holder 2 and the docking station 3 at which the alarm signals are triggered. An advantage of the claimed wireless theft detection system 1 is that the wireless theft detection system 1 comprising the device holder 2 and the docking station 3 is self-contained and, e.g., there is no need for a personal computer PC to set up the wireless theft detection system 1.

In the embodiment depicted in FIG. 2, the device holder 2 further comprises an acceleration sensor 201 for measuring a physical acceleration of the device holder 2. Preferably, the acceleration sensor 201 is adapted to measure a direction of the acceleration and an acceleration value. The device holder 2 comprises a light sensor 202 adapted to measure the light intensity surrounding the device holder 2. Further, the device holder 2 comprises one or more tampering sensors 203. The tampering sensors 203 may include mechanical, optical or electrical sensors for detecting a forceful removal of the device 9 from the device holder 2, e.g. by a shoplifter. In a simple embodiment, the tampering sensor 203 is adapted to detect a loss of contact between the device holder 2 and the device 9. In more sophisticated embodiments, the tampering sensors 203 may be arranged such that already a manipulation or tampering of the mechanical connection between the device holder 2 and the device 9 is detected. Optionally, the device holder 2 includes further tampering sensors 203 for detecting an attempt to remove the accessories installed on the device 9, e.g. the lens of the digital camera 9. Also, the device holder 2 comprises a battery (not shown) for powering the electronics within the device holder 2 and/or for charging an external battery of an electronic device 9. The device holder 2 is adjustable to set the correct voltage for charging the battery of the electronic device 9 which shall be connected to the device holder 2.

As illustrated in FIG. 1, the docking station 3 is adapted to be affixed to a surface 10 of e.g. a counter or exhibition booth. For example, the housing of the docking station 3 may comprise holes for fastening the docking station 3 on the surface 10 using screws. Moreover, the docking station 3 is electrically connectable to an external power supply.

For detecting an attempt to steal the device 9, the docking station 3 comprises tampering sensors 303 which may be similar to the tampering sensors 203 of the device holder 2. In particular, the docking station 3 comprises tampering sensors 303, e.g. mechanical, optical or electrical sensors, for detecting a forceful removal or for detecting an attempt of a forceful removal of the docking station 3 from the surface 10. In addition, the docking station 3 comprises tampering sensors 303 for detecting when the docking station 3 is electrically disconnected from an external power supply, e.g. an AC power supply. The docking station 3 further comprises a backup energy source e.g. a battery, a supercapacitor or a combination of both, to power the docking station 3 with its sensors and modules in case the docking station 3 is electrically disconnected from the external power supply.

The battery of the device holder 2, which is used to power both the modules and sensors of the device holder 2 and which may be used to charge a battery of the device 9, is chargeable via the docking station 3 by the external power source. In particular, both the device holder 2 and the docking station 3 are adapted to charge the battery of the device holder 2 when the device holder 2 is mechanically and electrically connected to the docking station 3. To this end, the device holder 2 and the docking station 3 comprise suitable wiring for connecting the battery of the device holder 2 with the external power source and suitable electronic circuitry for converting voltages and/or frequencies for efficiently charging the battery of the device holder 2.

The docking station 2 further comprises a battery status display 33 for displaying the charging status information of the battery of the device holder 2. In FIG. 1, the illustrated embodiment comprises a simple LED which is adapted to display the charging status information using different colors (e.g. green, orange, red). Nevertheless, more sophisticated display means can be applied to display more detailed information about the current charging status of the battery of the device holder 2.

Of course, the device holder 2 itself may comprise a further battery status display similar to the battery status display 33 of the docking station 3.

The first wireless communication module 204 is adapted to transmit the charging status information of the battery of the device holder 2 to the second wireless communication module 304. More concretely, the first processing module 205 of the device holder 2 is adapted to instruct the first wireless communication module 204 to transmit the charging status information to the second wireless communication module 304, and, upon reception of the charging status information, the second processing module 305 is adapted to instruct the battery status display 33 to display the received charging status information. Additionally, both the device holder 2 and the docking station 3 may be adapted to relay the charging status information via wired communication when the device holder 2 is mechanically and electrically connected to the docking station 3.

The wireless theft detection system 1 may comprise an external pairing key 8 for triggering a pairing process between the device holder 2 and the docking station 3. The docking station 3 comprises a pairing instruction detection module 30 adapted to detect a pairing instruction triggered by the external pairing key 8, and the docking station 3 is adapted to notify the device holder 2 of a secret identification information when the device holder 2 is mechanically connected with the docking station 3 and, at the same time, the pairing instruction detection module 30 detects the pairing instruction triggered by the external pairing key 8.

The pairing instruction may be a pairing instruction signal which is transmitted either wirelessly or via wired communication by the external pairing key 8 to the pairing instruction detection module 30. In the embodiment depicted in FIG. 1, the external pairing key 8 is an infrared (IR) key 8 which is adapted to wirelessly transmit the pairing instruction signal to the pairing instruction detection module 30, which is embodied as an IR receiver 30. Preferably, the IR key 8 is an IR programmable key frequency operated button (FOB) or a similar small electronic security token. Clearly, wireless communication techniques different from IR, specifically near field communication NFC techniques, may be used to transmit the pairing instruction signal. The transmission of the IR pairing instruction signal may be secured e.g. using random sequences. Since the transmission of the IR pairing instruction signal is very directive and with very low range (<20 cm), a clerk using the external pairing key 8 is required to hold the external pairing key 8 close to the pairing instruction detection module 30 of the docking station 3 to trigger the pairing process.

Alternatively, the external pairing key 8 may be electrically connectable to the pairing instruction detection module 30 to transmit the pairing instruction signal via a wired communication. Even a mechanical key 8 may be used as external pairing key 8 in order to trigger the pairing process. In this case, the pairing instruction detection module 30 comprises a conventional keyhole for detecting the pairing instruction. As a further alternative, the pairing instruction detection module 30 may be embodied as a fingerprint reader which is adapted to detect a predetermined fingerprint (e.g. of a clerk) as pairing instruction. In general, the pairing instruction triggered by an external pairing key 8 has to be encrypted in any form, and the external pairing key 8 and/or the encryption shall not be available or known to third persons, in particular to the customer of the retail store. In this way, only a clerk at the retail store is able to trigger a pairing process using the external pairing key 8.

At installation or maintenance time, the secret identification information is stored to an internal memory of the docking station 3, e.g. by the manufacturer of the wireless theft detection system 1. When both conditions are fulfilled simultaneously, i.e. when the docking station 3 and the device holder 2 are mechanically connected with each other and, at the same time, the pairing instruction detection module 30 detects the pairing instruction triggered by the external pairing key 8, the docking station 3 notifies the device holder 2 of the secret identification information. This notification is preferably propagated via a wired data connection, e.g. via the metallic pins 22, established between the docking station 3 and the device holder 2 when the latter are mechanically connected. Alternatively, the secret identification information is communicated from the docking station 3 to the device holder 2 via a wireless data connection.

In a retail store where a plurality of wireless theft detection systems 1 comprising each one docking station 3 and one device holder 2 are used in parallel, the secret identification information has to be unique, i.e. no two docking stations 3 have the same secret identification information stored on their internal memories. On the other hand, the same external pairing key 8 may be used to trigger the pairing process at all docking stations 3 in the retail store. After performing the described pairing process, the device holder 2 and the docking station 3 are associated with each other since the secret and unique identification information is known both on the device holder 2 and the docking station 3.

The device holder 2 is adapted to transmit the secret identification information via the wireless link to the docking station 3 for authenticating the device holder 2. Moreover, the secret identification information may be required for establishing the wireless link. In particular, the secret identification information may include a radio frequency RF network parameter required for establishing the wireless link. In this way, the pairing process makes it possible to establish the wireless link between the docking station 3 and the device holder 2.

In general, the pairing process triggered by the external pairing key 8 makes it possible to dynamically form pairs of docking stations 3 and device holders 2. For example, in a retail store where numerous docking stations 3 are affixed at an exhibition booth, the device holders 2 can be (a) flexibly attached to different devices 9 and (b) dynamically paired to different dockings stations 3. In this way, the devices 9 may be re-arranged in the exhibition booth without re-arranging the docking stations 3.

Since the alarm signals are generated both at the docking station 3 and the device holder 2, the pairing process makes it possible to quickly identify which device 9 and corresponding wireless theft detection system 1 has triggered the alarm.

Moreover, the docking station 3 is adapted to determine identification information associated with a device holder 2 when the device holder 2 is mechanically connected to the docking station 3 and to generate a notification signal when the identification information is not the secret identification information previously notified to the device holder 2. The notification signal may be an optical signal, an acoustical signal, or a combination of both. Thus, it becomes possible to inform a customer in case the customer has put the device 9 with the device holder 2 back to a docking station 3 not associated with the device holder 2.

The wireless theft detection system 1 further comprises an external alarm key 7 for stopping the alarm signals generated at the wireless theft detection system 1. The docking station 3 further comprises an alarm stop instruction detection module 31 adapted to detect an alarm stop instruction triggered by the external alarm key 7, wherein both the first processing module 205 and the second processing module 305 are adapted to control the first alarm module 24 and the second alarm module 34 to stop generating the first and the second alarm signal, respectively, when the alarm stop instruction detection module 31 detects the alarm stop instruction triggered by the external alarm key 7. Since the alarm stop instruction detection module 31 is located at the docking station 3, it is not possible to stop the first alarm signal generated at the device holder 2 when there is no wireless link between the docking station 3 and the device holder 2.

Optionally, both the first processing module 205 and the second processing module 305 are adapted to control the first alarm module 24 and the second alarm module 34 to stop generating the first and the second alarm signal, respectively, only when the device holder 2 is physically connected to the docking station 3 and, at the same time, the alarm stop instruction detection module 31 detects the alarm stop instruction triggered by the external alarm key 7. Thus, it is only possible to stop the alarm signals when the device holder 2 is physically connected to the docking station 3.

The structure and functionality of the external alarm key 7 may be similar or identical to the structure and functionality of the external pairing key 8. Analogously, the structure and functionality of the alarm stop instruction detection module 31 and the pairing instruction detection module 30 may be similar or identical. Specifically, the alarm stop instruction may be an alarm stop instruction signal which is transmitted either wirelessly or via wired communication by the external alarm key 7 to the alarm stop instruction detection module 31. In the embodiment depicted in FIG. 1, the external alarm key 7 is an IR key 7 which is adapted to wirelessly transmit the alarm stop instruction signal to the alarm stop instruction detection module 31, which is embodied as an IR receiver 31. A single external alarm key 7 may be used for a plurality of wireless theft detections systems 1 in a retail store. Due to the short communication range of IR signals, in case several wireless theft detections systems 1 trigger alarms simultaneously, a clerk has to hold the external alarm key 7 close to the alarm stop instruction detection module 31 of each docking station 3 to switch off the respective alarm signals generated by said docking station 3 and the corresponding device holder 2.

Again, the external alarm key 7 may be electrically connectable to the alarm stop instruction detection module 31, e.g. by a wire, in order to transmit the alarm stop instruction signal to the docking station 3. Alternatively, also a mechanical key 7 may be used as external alarm key 7 to switch off the alarm at the docking station 3.

When the alarm stop instruction detection module 31 receives an alarm stop instruction, the second processing module 305 instructs the second alarm module 34 to stop generating the second alarms signal. In parallel, the docking station 3 propagates the alarm stop instruction to the device holder 2 where the first processing module 204 also instructs the first alarm module 24 to stop generating the first alarm signal.

Alternatively, the functionality of the external pairing key 8 and the external alarm key 7 can be combined in a single device. For example, this single device comprises two buttons, one for switching off the alarm signals and one for initiating the pairing process between a device holder 2 and a docking station 3. Similarly, the docking station 3 may comprise only a single detection module which combines the functionality of the pairing instruction detection module 30 and the alarm stop instruction detection module 31.

The device holder 2 and the docking station 3 further each comprise internal wiring and/or a central BUS (not shown) to connect the above hardware components together and provide at least one path for digital communication therebetween. Specifically, in the device holder 2, the first processing module 205 is electrically connected to the acceleration sensor 201, the light sensor 202, the tampering sensor 203, the first wireless communication module 204 and the alarm module 24. In the docking station 3, the second processing module 305 is electrically connected to the pairing instruction detection module 30, the alarm stop instruction detection module 31, the tampering sensor 303, the second wireless communication module 304, the second alarm module 34 and the battery status display 33.

In the following, situations will be discussed in which a security critical event occurs at the device holder 2 which triggers the alarm signals at both the device holder 2 and the docking station 3. It is therefore assumed that the device holder 2 notifies the docking station 3 about the occurrence of the security critical event via a wired data connection, e.g. via the metallic pins 22, established between the docking station 3 and the device holder 2 when the latter are mechanically connected. Alternatively, the latter notification is communicated from the device holder 2 to the docking station 3 via a wireless data connection, e.g. via the wireless link.

Firstly, both the first processing module 205 and the second processing module 305 are adapted to control the first alarm module 24 and the second alarm module 34 to generate the first and the second alarm signal, respectively, when the light intensity measured by the light sensor 202 is below a predetermined threshold light intensity value.

The threshold light intensity value is determined e.g. in a pre-operational phase. Thus, if a shoplifter hides the device holder 2 in a dark area, e.g. in a bag, the wireless theft detection system 1 triggers an alarm on both the device holder 2 and the docking station 3. That is, even if the first alarm signal (optical and/or acoustical) of the first alarm module 24 is not perceivable because the device holder 2 is hidden in a bag, still the second alarm signal generated at the docking station 3 will be perceivable.

Secondly, both the first processing module 205 and the second processing module 305 are adapted to control the first alarm module 24 and the second alarm module 34 to generate the first and the second alarm signal, respectively, when the acceleration of the device holder 2 measured by the acceleration sensor 201 exceeds a predetermined threshold acceleration value.

Also the threshold acceleration value is determined e.g. in a pre-operational phase. Thus, it becomes possible to detect if a thief attempts to run away with the device holder 2. Optionally, in case the acceleration sensor 201 is adapted to measure both the direction of the acceleration and the acceleration value, the first processing module 205 differentiates between a predominantly vertical acceleration whose acceleration value exceeds the predetermined threshold acceleration value and a predominantly horizontal acceleration whose acceleration value exceeds the predetermined threshold acceleration value. If a predominantly vertical acceleration is detected, it is assumed that e.g. the device holder 2 is falling down from the docking station 3 or was accidentally dropped by a customer when testing the device 9. Consequently, the alarm signals are not generated when a mainly vertical acceleration is detected. Thus, it becomes possible to avoid false alarms in certain situations.

Thirdly, both the first processing module 205 and the second processing module 305 are adapted to control the first alarm module 24 and the second alarm module 34 to generate the first and the second alarm signal, respectively, when a tampering sensor 203 on the device holder 2 has detected an attempt of a forceful removal of the device 9 from the device holder 2. Additionally or alternatively, both alarm signals are generated when further tampering sensors 203 detect an attempt to remove the accessories installed on the device 9.

Fourthly, both the first processing module 205 and the second processing module 305 are adapted to control the first alarm module 24 and the second alarm module 34 to generate the first and the second alarm signal, respectively, when the battery level of the battery of the device holder 2 is low, i.e. below a defined threshold value. In addition, the charging of the external battery of the device 9 is stopped when the battery level of the device holder's 2 battery is low.

Next, situations will be discussed in which a security critical event occurs at the docking station 3 which triggers the alarm signals at both the device holder 2 and the docking station 3. It is therefore assumed that the docking station 3 notifies the device holder 2 about the occurrence of the security critical event via a wired data connection, e.g. via the metallic pins 22, established between the docking station 3 and the device holder 2 or, alternatively, the latter notification is communicated from the device holder 2 to the docking station 3 via a wireless data connection, e.g. via the wireless link.

Both the first processing module 205 and the second processing module 305 are adapted to control the first alarm module 24 and the second alarm module 34 to generate the first and the second alarm signal, respectively, when the docking station 3 is electrically disconnected from an external power supply. When the docking station 3 is electrically disconnected from an external power supply, the docking station's 3 backup energy source powers the modules and sensors of the docking station 3 and allows detecting the interrupted external power supply. Specifically, the backup energy source powers the second alarm module 34 to generate the second alarm signal for a limited amount of time. Thus, it becomes possible to detect an attempt to steal the device 9 by interrupting the external power supply to the whole wireless theft detection system 1.

Moreover, both the first processing module 205 and the second processing module 305 are adapted to control the first alarm module 24 and the second alarm module 34 to generate the first and the second alarm signal, respectively, when a tampering sensor on the docking station 3 has detected an attempt of a forceful removal of the docking station 3 from the surface 10 to which the docking station 3 was affixed. Thus, it becomes possible to detect theft of the device 9 together with the device holder 2 and the docking station 3 by removing the docking station 3 from the surface 10.

In order to prevent false detection, i.e. the generation of alarm signals in case no attempt to steal the device 9 has occurred, dedicated algorithms running on the first processing module 205 and/or the second processing module 305 take into account the input of the acceleration sensor 201, the light sensor 202, the various tampering sensors 203, 303 as well as the quality of the wireless link generated at the first wireless communication module 204 and/or at the second wireless communication module 304.

Furthermore, dependent on a status of the wireless theft detection system 1, the first alarm module 24 and/or the second alarm module 34 generate different optical and/or acoustical notification and alarm signals. For example, the alarm modules generate a first light sound when the pairing process has succeeded, a second light sound when the battery level of the battery of the device holder 2 is below a well-defined threshold value, and a medium sound when a customer does not return the device holder 2 to the right docking station 3. The first and the second alarm signals are substantially louder than the above notification signals. Corresponding optical signals (e.g. LED) are generated at the first alarm module 24 and/or the second alarm module 34.

Link quality information may be not generated at both the device holder 2 and the docking station 3 but only at the device holder 2 or at the docking station 3. For example, only the second wireless communication module 304 at the docking station 3 is adapted to generate the second link quality information, e.g. from link measurement signals periodically transmitted by the device holder 2. More precisely, the first wireless communication module 204 of the device holder 2 periodically transmits, via the wireless link, link measurement signals to the second wireless communication module 304 of the docking station 3. The transmitted link measurement signal is suitable for generating the second link quality information at the docking station 3. The frequency of the transmission of the link measurement signals is adjustable but should be high enough to guarantee a fast response time of the wireless theft detection system 1 in case of alarms.

If link quality information is only generated at the docking station 3, the docking station 3 notifies the device holder 2 whether an alarm shall be triggered because the quality of the wireless link is below the predetermined threshold value. In particular, the docking station 3 notifies the device holder 2 whether the docking station 3 has judged that the quality of the wireless link, which is based on the second link quality information generated at the docking station 3 upon reception of a link measurement signal, is below the predetermined threshold value. In other words, the docking station 3 notifies the device holder 2 whether the estimated distance between the docking station 3 and the device holder 2 exceeds a threshold distance corresponding to the predetermined threshold value.

In the described situation, the docking station 3 either explicitly notifies the device holder 2 that an alarm shall be triggered using an explicit feedback signal or, alternatively, the docking station 3 implicitly notifies the device holder 2 by not sending a feedback signal at a predetermined timing. If the device holder 2 does not receive said feedback signal at the predetermined timing, the device holder 2 assumes that an alarm has been triggered at the docking station 3 and the first alarm module 24 at the device holder 2 generates the first alarm signal. The implicit notification by not sending a feedback signal has the advantage that, in case of a severe deterioration of the wireless channel, it is still possible that the docking station 3 notifies the device holder 2 that an alarm shall be triggered.

The other way round, if link quality information is only generated at the device holder 2, the device holder 2 notifies the docking station 3 whether an alarm shall be triggered because the quality of the wireless link is below the predetermined threshold value. Again, explicit or implicit notification using corresponding feedback signals may be applied.

If both the device holder 2 and the docking station 3 periodically transmit link measurement signals over the wireless link and both the device holder 2 and the docking station 3 generate corresponding link quality information, both the device holder 2 and the docking station 3 may judge individually whether the quality of the wireless link is below the predetermined threshold value.

Finally, the generation of alarm signals is stopped at both the docking station 3 and the device holder 2 when either the docking station 3 or the device holder 2 determines that the quality of the wireless link is above the predetermined threshold value. Optionally, it is required to physically connect the device holder 2 with the docking station 3 to stop the alarm signal at the device holder 2 and the docking station 3.

Obviously, numerous modifications and variations of the present disclosure are possible in light of the above teachings. It is therefore to be understood that within the scope of the appended claims, the disclosure may be practiced otherwise than as specifically described herein.

### CROSS-REFERENCE TO RELATED APPLICATIONS

The present application claims priority of EP patent application No. 12 007 383.8 filed on 26 Oct. 2012, the entire contents of which are incorporated herein by reference.

1. A wireless theft detection system, comprising
a device holder including
a first wireless communication module adapted to establish a wireless link with an external second wireless communication module,
a first alarm module adapted to generate a first alarm signal, and
a first processing module adapted to communicate with the first wireless communication module and to control the first alarm module, and
a docking station including
the second wireless communication module adapted to establish the wireless link with the first wireless communication module of the device holder,
a second alarm module adapted to generate a second alarm signal, and
a second processing module adapted to communicate with the second wireless communication module and to control the second alarm module,
wherein the first wireless communication module is adapted to generate first link quality information or the second wireless communication module is adapted to generate second link quality information, and both the first processing module and the second processing module are adapted to control the first and the second alarm module to generate the first and the second alarm signal, respectively, when a quality of the wireless link is below a predetermined threshold value.

2. The wireless theft detection system according to claim 1, wherein the docking station comprises a pairing instruction detection module adapted to detect a pairing instruction triggered by an external pairing key, and the docking station is adapted to notify the device holder of a secret identification information when the device holder is mechanically connected with the docking station and, at the same time, the pairing instruction detection module detects the pairing instruction triggered by the external pairing key.

3. The wireless theft detection system according to claim 2, wherein the device holder is adapted to transmit the secret identification information via the wireless link to the docking station for authenticating the device holder.

4. The wireless theft detection system according to claim 2, wherein the secret identification information is required for establishing the wireless link.

5. The wireless theft detection system according to claim 2, wherein the docking station is adapted to determine identification information associated with a device holder when the device holder is mechanically connected to the docking station and to generate a notification signal when the identification information is not the secret identification information previously notified to the device holder.

6. The wireless theft detection system according to claim 1, wherein the docking station further comprises an alarm stop instruction detection module adapted to detect an alarm stop instruction triggered by an external alarm key, wherein both the first processing module and the second processing module are adapted to control the first and the second alarm module to stop generating the first and the second alarm signal, respectively, when the alarm stop instruction detection module detects the alarm stop instruction triggered by the external alarm key.

7. The wireless theft detection system according to claim 1, the device holder further comprising a light sensor adapted to measure a light intensity surrounding the device holder, and both the first processing module and the second processing module are adapted to control the first and the second alarm module to generate the first and the second alarm signal, respectively, when the light intensity measured by the light sensor is below a predetermined threshold light intensity value.

8. The wireless theft detection system according to claim 1, the device holder further comprising an acceleration sensor adapted to measure an acceleration of the device holder, and both the first processing module and the second processing module are adapted to control the first and the second alarm module to generate the first and the second alarm signal, respectively, when the acceleration of the device holder exceeds a predetermined threshold acceleration value.

9. The wireless theft detection system according to claim 1, wherein both the first processing module and the second processing module are adapted to control the first and the second alarm module to generate the first and the second alarm signal, respectively, when the docking station is electrically disconnected from an external power supply.

10. The wireless theft detection system according to claim 1, wherein both the first processing module and the second processing module are adapted to control the first and the second alarm module to generate the first and the second alarm signal, respectively, when a tampering sensor on the device holder has detected an attempt of a forceful removal of the device from the device holder or when another tampering sensor on the docking station has detected an attempt of a forceful removal of the docking station from a surface to which the docking station was affixed.

11. The wireless theft detection system according to claim 1, wherein the device holder comprises a battery.

12. The wireless theft detection system according to claim 11, wherein the first wireless communication module is adapted to transmit charging status information of the battery of the device holder to the second wireless communication module and the docking station comprises a displaying means for displaying the charging status information.

13. The wireless theft detection system according to claim 11, wherein the docking station is electrically connectable to an external power supply and both the device holder and the docking station are adapted to charge the battery of the device holder when the device holder is mechanically connected to the docking station.

14. A method for a wireless theft detection system comprising a device holder and a docking station, comprising the steps of:
establishing a wireless link between the device holder and the docking station,
determining a quality of the wireless link in at least one of the device holder and the docking station,
generating a first alarm signal in the device holder when the determined quality of the wireless link is below a predetermined threshold value, and
generating a second alarm signal in the docking station when the determined quality of the wireless link is below the predetermined threshold value.

15. A computer program for a wireless theft detection system comprising a device holder and a docking station, for instructing microprocessors of the device holder and the docking station such that the device holder and the docking station perform the steps according to claim 14.
